(19) United States
(12) Patent Application Publication
(10) Pub. No.: US 2009/0115943 A1
(43) Pub. Date: May 7, 2009

(54) LOW BIREFRINGENCE LIGHT CONTROL FILM AND METHODS OF MAKING

(75) Inventor: Gary E. Gaides, Woodbury, MN (US)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY

(21) Appl. No.: 12/266,036

(22) Filed: Nov. 6, 2008

Related U.S. Application Data
(60) Provisional application No. 60/986,135, filed on Nov. 7, 2007.

(51) Int. Cl. G02F 1/1335; B29D 11/00

(52) U.S. Cl. 349/96; 264/1.34

(57) ABSTRACT

A method of manufacturing a composite light control film including providing a first layer. A second layer, in a formable state, is also provided and is patterned to form a plurality of microstructures defining a plurality of cavities therebetween. The patterned second layer is hardened to the first layer and the cavities are filled with a light absorbing material. An optional third film can be attached to the second layer opposite the first film to form a composite light control film. The resultant film exhibits a Brightness Variation Factor of less than 10% and can be disposed between a light chamber of a backlight unit and a liquid crystal display assembly in forming an LCD device.

### CROSS REFERENCE TO RELATED APPLICATION

This application claims the benefit of U.S. Provisional Patent Application No. 60/986,135, filed Nov. 7, 2007, the disclosure of which is incorporated by reference herein in its entirety.

### FIELD

The present disclosure relates to light control films useful with, for example, display devices such as liquid crystal display (LCD) devices. More particularly, it relates to low birefringence light control films and methods of manufacturing thereof, as well as assembly of such films as an internal component of a display device.

### BACKGROUND

LCD devices are widely used in variety of display applications, and provide marked improvements over conventional display formats such as cathode ray tubes. In general terms, an LCD device includes an LCD panel, two layers of light polarizing material (“polarizers”), and a light source. The light source can simply be a reflective material that reflects external light. Alternatively, the LCD device desirably includes its own, internal source of light (or “backlight unit”). Unless otherwise specified, as used throughout this disclosure, an “LCD device” is in reference to an LCD construction including an internal source of light.’

The LCD panel may contain a quantity of twisted nematic liquid crystal material, and can have a front (or viewing) side and a back side opposite the front side. A series of electrodes (e.g., thin-film transistors) are associated with the liquid crystal material to effectively provide a large number of picture elements or pixels (or even subpixels). The LCD panel is sandwiched between the polarizers, with the polarizer at the back side of the LCD panel serving as a rear polarizer and the polarizer at the front side serving as a front polarizer (or absorptive analyzer). The polarizers are placed so that the polarization axes of the two polarizers form a certain angle, for example a right angle. Finally, the light source is arranged to direct light onto the rear polarizer for subsequent interaction with the rear polarizer and the LCD panel. An electric current passed through a selected electrode of the LCD panel causes the liquid crystals associated with that electrode to align so that light cannot pass through the front polarizer due to the light no longer matching the polarization angle of the front polarizer (or vice-versa).

Construction and operation of LCD devices have greatly evolved over time. For example, significant advancements have been witnessed in the control of the electrodes otherwise arranged in a matrix (e.g., passive and active matrix control). Further, color filters and corresponding subpixel control are now commonly available.

Another area of improvement relates to the light source. Backlight units for LCD device applications are typically either a direct-type backlight or an edge-type backlight. Direct backlights include one or more light sources placed directly behind (or “below”) the rear polarizer (and thus the back side of the LCD panel) within the output area of the LCD device. Edge-type backlights include a light-guide plate and a light source that supplies light to the light-guide plate from the edge face of the plate. While these light sources are highly viable, concerns have been raised as to the relatively large viewing angle provided by conventional LCD devices. More particularly, with either of the backlight unit constructions described above, because the light beam is directly transmitted through the LCD panel toward a viewer of the display at effectively uncontrolled angles, the display can been viewed by persons standing at an angle relative to the display itself. Similarly, the light emitted from the LCD can project on to surfaces situated at an angle relative to the display (e.g., for automobile LCD device applications, a reflection or light transmission from the LCD device may be directed on to the vehicle's windshield, which in turn may interfere with the vision of the driver).

To address the above concerns, light control films have been suggested. Light control or light-collimating films are generally configured to provide a series of restricted optical apertures through which light can pass (separated by regions of light absorbing material through which light cannot pass), and are particularly useful in applications where limited angles of visibility and/or transmission of light is desired. At normal incidence (i.e., 0 degree viewing angle), where a viewer is looking at an image through the light-collimating film (or where light is being transmitted through the light-collimating film) in a direction that is perpendicular to the film surface, the image (or transmitted light) is viewable. As the viewing angle increases, the amount of light transmitted through the light-collimating film decreases until a maximum viewing angle (or maximum transmitting angle) is reached where substantially all of the light is blocked by the light absorbing material and the image is no longer viewable. Given these characteristics, light control films have been incorporated into some LCD display constructions, for example as an outermost layer on the front or display side of the LCD panel.

Light control films have conventionally been manufactured using a skiving-based methodology, and are generally described as having opaque plastic louvers lying between strips of clear plastic. For example, U.S. Pat. No. Re 27,617 (Olsen) describes a process of making a louvered light control film in which a cylindrical billet of alternating layers of relatively low optical density (e.g., transparent) plastic film and relatively high optical density (e.g., colored or black) plastic film is initially formed. The billet is compressed and heated, causing the layers to fuse together. The fused billet is subsequently subjected to a skiving (e.g., slicing) operation that results in a continuous sheet with alternating segments of optically high density and optically low density. The high optical density layers provide light-collimating louver elements which, as illustrated in the patent, may extend orthogonally to the surface of the resulting louvered plastic film. U.S. Pat. No. 3,707,416 (Stevens) discloses a skiving-type process whereby the light-collimating louver elements can be canted with respect to the surface of the light control film.

A similar manufacturing technique entails thermo-compressing a laminated block of alternating layers of relatively low optical density film and relatively high optical density film. The so-formed block is then repeatedly sliced or skived perpendicularly to, or at a certain angle with respect to, the surface thereof to form sheets of louvered film. This approach is described, for example, in PCT Pub. No. WO2005/092544 (Shewa) and U.S. Pat. No. 2,053,173 (Astima).

### SUMMARY

Aspects in accordance with principles of the present disclosure relate to a method of manufacturing a composite light control film. The method includes providing a first layer as a film. A second layer in a formable state is also provided and is patterned to form a plurality of microstructures defining a plurality of cavities therebetween. The patterned second layer is solidified on the first layer, and the cavities are filled with a light absorbing material. In some embodiments, an optional third layer is attached to the second layer opposite the first layer. Regardless, a composite light control film results that exhibits a Brightness Variation Factor of less than 10%, and in some embodiments less than 5%.

Other aspects in accordance with principles of the present disclosure relate to a method of manufacturing an LCD device. The method includes forming a composite light control film as described above, with the light control film exhibiting a Brightness Variation Factor of less than 10%. The composite light control film is disposed between a light chamber of a backlight unit and a liquid crystal display assembly in forming the LCD device. In some embodiments, the method further includes providing a reflective polarizer brightness enhancement film, with the light control film being optically positioned between the brightness enhancement film and the liquid crystal display assembly. In other embodiments, the method includes providing the first and the optional third layers as low birefringence polycarbonate films.

Yet other aspects in accordance with principles of the present disclosure relate to an LCD device including a liquid crystal display assembly, a composite light control film, and a backlight unit. The liquid crystal display assembly includes a liquid crystal display panel optically positioned between a front polarizer and a rear polarizer. The backlight unit includes a light chamber. The light control film is positioned optically between the liquid crystal display assembly and the light chamber. The light control film includes a base film, an intermediate layer, and a light absorbing material. The base film is a low birefringence film. The intermediate layer is formed on the base film to define a first major face opposite the base film. Further, the intermediate layer forms a plurality of microstructures defining a plurality of cavities therebetween. In this regard, the cavities are open relative to the first major face of the intermediate layer. The light absorbing material is disposed within the cavities. An optional top film, formed as a low birefringence film, can be adhered to the first major face of the intermediate layer in some embodiments. With this construction, light beams generated at the light chamber pass through the light control film and are directed to the liquid crystal display assembly at transmission angles dictated by the light control film. In some embodiments, the LCD device further includes a brightness enhancement film, such as a reflective polarizer film, positioned between the light chamber and the light control film. In yet other embodiments, the LCD device is configured for assembly within a dashboard of an automobile.

Yet other aspects in accordance with principles of the present disclosure relate to a composite film for use in an LCD device including a liquid crystal display assembly and a backlight unit. The composite film includes a first low birefringence film, an intermediate layer, a light absorbing material, and a second low birefringence film. The intermediate layer is formed on the first film and defines opposing, first and second major faces, and a plurality of microstructures defining a plurality of cavities therebetween. In this regard, the cavities are open relative to the first major face. The light absorbing material is disposed within each of the cavities. Finally, the second film is secured to the first major surface of the intermediate layer to encase the light absorbing material within the cavities. In this regard, the composite light control film exhibits a Brightness Variation Factor of less than 10%.

### BRIEF DESCRIPTION OF THE DRAWINGS

FIG. 1 is a schematic view of an LCD device including a light control film in accordance with principles of the present disclosure;

FIG. 2A is a perspective view of a light control film useful with the LCD device of FIG. 1;

FIG. 2B is a perspective view of the light control film of FIG. 2A upon final construction;

FIG. 3 is a schematic illustration of a portion of a system and method for manufacturing a light control film useful with the LCD device of FIG. 1;

FIGS. 4A-4C are cross-sectional views of light control films in accordance with the present disclosure and illustrating differing louver angle constructions;

FIG. 5 is a schematic illustration of an alternative LCD device including a light control film in accordance with principles of the present disclosure; and

FIG. 6 schematically illustrates useful measurement locations along a viewing face of an LCD-type device for determining Brightness Variation Factor and Color Variation Factor properties of a light control film.

### DETAILED DESCRIPTION

Skived-type light control films have proven to be highly viable for many end-use applications in which intended viewer privacy is of importance, including many LCD-based devices. The light control film is adhered to an exterior of the viewing surface, thereby narrowing the field of view. For some applications, however, it is less desirable for the light control film to be located on the viewing surface due to possible damage. For example, LCD devices are often present in automobiles (to provide navigational information, operational status information, etc.). With these applications, direct user interaction (e.g., touching) with the exterior-most layer of the display device is routinely expected, requiring that an exterior light control film be more rigorously formed and/or that a protective layer be added (e.g., providing desired abrasion resistance, hardness, and reflectance properties). In either instance, additional costs are encountered. To address these concerns for automotive and a number of other LCD device end use applications, the skived-type light control film can instead be positioned within the LCD device's housing, optically adjacent the back side of the LCD panel. Light is transmitted through the light control film prior to interaction with the LCD panel, thereby achieving the desired light transmission direction control effect but with virtually no opportunity for damage to the light control film.

Internal placement of louvered light control film within an LCD device as described above is known. For example, louvered light control films available from 3M Company under the Vikuiti® brand are highly popular for use as an internal component of various LCD devices, including automotive LCD device applications. Other additional, internal LCD device components have likewise proven quite beneficial, such as Vikuiti® brand Brightness Enhancement Films (BEF) or Dual Brightness Enhancement Films (DBEF). Regardless of the internal construction, end-users and manufacturers have come to demand ever increasing uniformity in brightness and color, as well as improved clarity from the LCD device. While the advantages provided by light control film are equally desired, difficulties in meeting all of these preferences may arise.

For example, the manufacturing steps associated with skived light control films may introduce discontinuities or other imperfections into the resultant film. By way of reference, three important process variables associated with the skiving process are temperature of the material during molding, temperature of the material being “sliced,” and the tension under which the sheet is maintained during the cutting process. Deviations from a desired temperature may result in “chatter” and/or distortions in the skived sheet. Similarly, non-uniform sheet tension may result in distortions in the louvers. These and possibly other process variables may give rise to a birefringence characteristic in the resultant film. For many end uses, a birefringence in the light control film is of minimal or no concern. However, for some applications that otherwise require preservation of light polarization, such as the above-described use in automotive LCD devices, birefringence may be problematic.

The above described introduction of birefringence into a light control film may be uniform across the sheet, or more likely with skiving techniques, random or non-uniform. Where a uniformly birefringent light control film is inserted between two polarizers (such as with an LCD device including a rear polarizer at the LCD panel and a brightness enhancement film formed as a reflective polarizer at the backlight unit), the light control film may cause a uniform reduction in the overall brightness of the film stack (in the presence of a light source) if the optical axes of the birefringent film are not aligned with the two polarizers. Introduction of a non-uniformly birefringent light control film between two aligned polarizers is potentially even more problematic, reducing the overall brightness of the film stack in a non-uniform manner when the optical axes of the birefringent light control film are not aligned with the polarizer. For example, if such a non-uniformly birefringent light control film were positioned between a reflective polarizer brightness enhancement film and the rear absorbing polarizer at the LCD panel, then non-uniformity in display brightness may result. LCD device manufacturers strive to minimize any brightness variations, and thus will not accept components that overtly contribute to non-uniformities. As such, light control films for use in LCD device applications must meet exacting brightness uniformity standards. In order to meet display manufacturer brightness variation tolerances (e.g., less than 10% variation in brightness), light control film manufacturers using conventional skiving techniques may often be required to discard a relatively large amount of produced film due to birefringence/brightness variation concerns. Additionally, in some instances, variations in the louver angles (i.e., the viewing angle of a particular louver where brightness or transmission is at a maximum) associated with the light control film may also contribute to display brightness variations, and represent a separate process-dependent variable that may be difficult to consistently control with skiving techniques. As a point of reference, skiving processes for making light control film are generally incapable of yielding piece parts with acceptable variation in louver angle (e.g., not greater than ±2 degrees) absent a costly sorting step.

In light of the above, a need exists for low birefringence light control films useful for various applications, such as an internal component of an LCD device, as well as LCD devices incorporating such light control films.

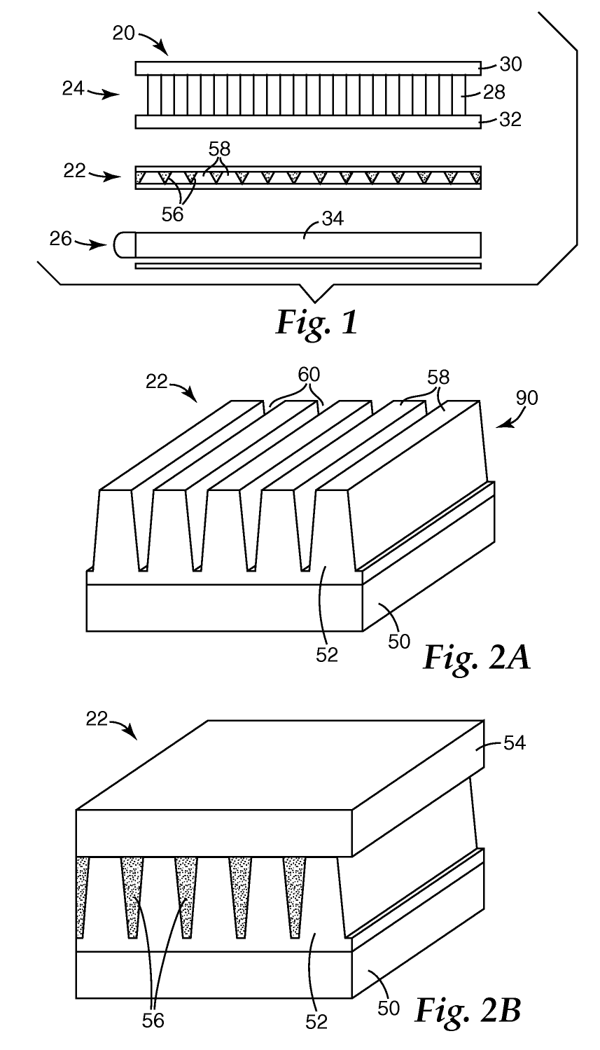

Aspects of the present disclosure relate to light control, polarization preservation composite films, and related methods of manufacture, useful for various display applications, for example as an internal component of an LCD device. With this in mind, one example of an LCD device 20 including a light control film 22 in accordance with principles of the present disclosure is schematically represented in FIG. 1. In addition to the light control film 22, the LCD device 20 includes a liquid crystal display assembly (or “LCD assembly”) 24 and a backlight unit 26. The LCD assembly 24 can have a variety of different constructions currently known or in the future developed, and generally includes a liquid crystal display panel (or “LCD panel”) 28 sandwiched between a front polarizer (or absorptive analyzer) 30 and a rear polarizer 32, with the front polarizer 30 arranged at a viewing side of the LCD panel 28. In basic terms, the LCD panel 28 contains a liquid crystal material along with energy sources (e.g., electrodes) that cause the liquid crystal material in a corresponding region to align (or not align) in the presence or absence of electrical energy, as is known in the art. The backlight unit 26 can also assume a variety of constructions (e.g., a direct backlight or edge backlight), and generally provides a light chamber 34 that is positioned to transmit light toward the LCD assembly 24. The light control film 22 is optically located between the light chamber 34 and the LCD assembly 24, affecting light from the light chamber 34 as described below. In this regard, the LCD device 20 can include additional components that further act upon light beams prior to interaction with the LCD assembly 24 as described below; more generally, however, the light control film 22 exhibits uniform, low birefringence characteristics that have surprisingly been found to maintain desired brightness and/or color uniformity of the LCD device 20 while reducing mass production costs associated with the LCD device 20, especially for automotive applications.

With the above in mind, one configuration of the light control film 22 is shown in FIGS. 2A and 2B at various stages of manufacture (e.g., FIG. 2A represents the light control film 22 at an intermediate state of manufacture, whereas FIG. 2B represents one embodiment of light control film 22). The light control film 22 can also be referred to as a microstructured light-collimating article (or “microstructured light control film”), and includes a first layer or film 50, a second layer or film 52, an optional third layer or film 54 (FIG. 2B), and a light absorbing material 56 (FIG. 2B). The second layer 52 is maintained by the first film 50, and forms a plurality of microstructures or microribs 58 combining to define a plurality of cavities 60 (shown in FIG. 2A). The light absorbing material 56 is disposed within the cavities 60, and can be retained therein via the optional third film 54 as represented in FIG. 2B. Alternatively, the third film 54 can be omitted such that an acceptable light control film in accordance with the present disclosure comprises the first film 50, the second layer 52, and the light absorbing material 56. As described in greater detail below, the material(s) selected for the layers or films 50-54 in conjunction with the methods of manufacture combine to achieve the uniform, low birefringent properties of the light control film 22 in a manner not previously considered available or even feasible for end applications such as the LCD device 20 (FIG. 1).

More particularly, unlike conventional skiving-produced light control films used as an internal LCD device component, the light control film 22 (and resultant LCD device 20 (FIG. 1)) of the present disclosure is formed via a cast and cure or mold and cure process. As a point of reference, while cast or mold processing has been considered for light control film, these techniques are specifically employed for producing privacy film, and not for internal LCD device applications. While privacy film is highly beneficial, it may not be optimal for internal LCD device usage, especially with applications where polarization preservation is important. Light control film casting or molding methodologies are directly akin to injection molding and thus are normally viewed as introducing significant amounts of stress into the resultant part or film. These inherent stresses have conventionally been assumed to drastically affect the birefringence of the so-produced light control film. For traditional privacy film applications (e.g., external display privacy screen for computer monitors and ATMs), birefringence is of minimal concern, such that cast or mold manufacturing has been viewed as being acceptable methods of manufacture. With many internal LCD device applications, however, birefringence, especially non-uniform birefringence (and the resultant negative impact on overall display uniformity), cannot be tolerated. It is surmised, therefore, that the failure of the prior art to even consider molding- or casting-produced light control film for internal LCD device applications follows from the conclusions that skiving techniques are the only available processes capable of generating acceptable birefringence properties. The present disclosure overcomes these deficiencies, providing the light control film 22 as a continuous cast or molded article in a manner surprisingly found to exhibit uniform, low birefringence characteristics.

With the above in mind, the microstructured light control film 22 can be formed by appropriate casting or molding microreplication techniques including, but limited to, molding and curing (e.g., radiation curing). The term “microreplication” includes a process whereby microstructured features are imparted from a master or a mold onto an article. The master is provided with a microstructure, for example by micro-machining techniques such as diamond turning, laser ablation or photolithography. The surface or surfaces of the master having the microstructure may be covered with a hardenable material so that when the material is hardened, an article is formed that has a negative replica of the desired microstructured features. The microreplication may be accomplished using rolls, belts, or other apparatuses known in the art.

For example, the microstructured composite light control film 22 can be formed by the steps of (a) preparing a polymerizable or curable composition (i.e., the polymerizable composition of the second layer 52); (b) depositing the polymerizable composition onto a preformed base (e.g., the base layer 50); (c) moving the layer of polymerizable composition/base layer against a master negative microstructured molding surface such that surface features of the master negative are imparted into the polymerizable composition; and (d) curing the composition. The deposition temperature can range from ambient temperature (i.e., 25° C.) to 180° F. (82° C.). The master can be metallic, such as nickel, nickel-plated or chrome-plated copper or brass, or can be a thermoplastic material that is stable under the polymerization conditions, and that preferably has a surface energy that allows clean removal of the polymerized material from the master. One or more of the surfaces of the base film can optionally be primed or otherwise treated to promote adhesion of the polymerizable composition (i.e., the second layer 52) to the base.

The particular chemical composition and thickness of the base layer/film material can depend upon the requirements of the particular LCD device 20 that is being constructed. That is, balancing the needs for strength, clarity, temperature, resistance, surface energy, adherence to the polymerizable composition/layer, among others. The thickness of the base layer 50 is typically at least about 0.025 mm and more typically at least about 0.100 mm. Further, the base layer 50 generally has a thickness of no more than about 0.5 mm.

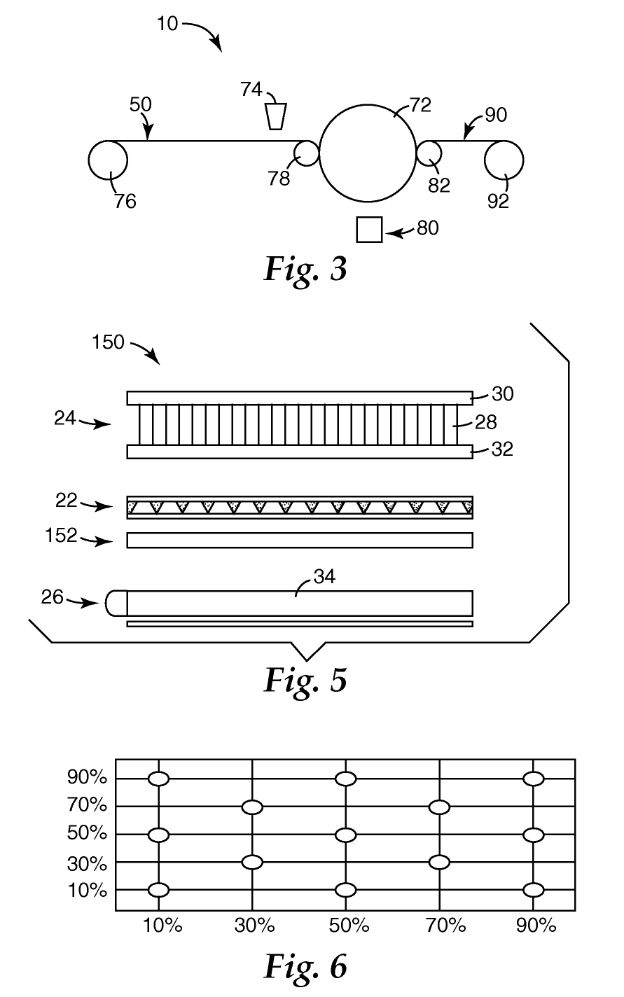

Commensurate with the above, one non-skiving system and method for forming the light control film 22 is generally shown at 70 in FIG. 3. A master roll 72 (a patterned or die roll) is provided, having the desired microstructure (or microcavity) pattern formed on its outer surface. A source 74 of transparent radiation curable resin (i.e., the material of the second layer 52 (FIG. 2A)) in polymerizable form is positioned to deposit the radiation curable resin onto a length of the preformed base film 50, that can otherwise be extended from a supply roll 76. The source 74 is positioned “upstream” of the master roll 72 and a secondary roller 78 is provided that establishes a nip with the master roll 72. Thus, following deposition of the polymerizable material of the second layer 52 onto the base layer 50, the secondary roller 78 forces the deposited material (i.e., the second layer 52 in a formable state) against the master roll 72 as the master roll 72 rotates (counterclockwise relative to the orientation of FIG. 3). As a result, the pattern of the master roll 72 is imparted into the polymerizable material of the second layer 52. Thereafter, the patterned polymerizable material is hardened, for example via operation of a radiation device 80. An additional secondary roller 82 can then be employed to assist in removing the resultant microstructured composite 90 from the patterned roll 72, and the composite 90 can be wound on a roll 92. As a point of reference, FIG. 2A identifies the microstructured composite 90 following removal from the patterned roll 72.

Other casting or molding techniques can also be employed to produce the microstructured composite 90. For example, in addition to coating the preformed base film 50 with the polymerizable material of the second layer 52 (in a formable state), an additional quantity of the polymerizable material can be deposited into the microcavities of the master roll 72. With this approach, as the base film 50/coated polymerizable material is forced along the master roll 72, the polymerizable material from the microcavities of the master roll 72 is deposited onto the web in a form matching the microstructured shape of the master roll 72. Subsequently, the now-patterned second layer 52 is cured, resulting in the microstructured composite 90.

Regardless of how the microstructured composite 90 is formed, the light absorbing material 56 (FIG. 2B) is then dispensed or filled (partially or entirely) into the cavities 60 (FIG. 2A). For example, the light absorbing material 56 is coated onto the outward facing surface of the microstructured composite or film 90 (i.e., into the “open” side of the formed cavities 60). The light absorbing material 56 is embedded onto the cavities 60 via pressure exerted by a rubber nip roll pressed against a steel cylinder roll. Excess quantities of the light absorbing material 56 is removed from the upper land surface of the microstructured composite 90 by a doctor blade positioned on the opposite side of the steel cylinder roll. The deposited light absorbing material 56 can then be hardened (e.g., radiation polymerized using UV lamp curing techniques). Other known techniques for applying the light absorbing material 56 can alternatively be used.

Filling (including partial filling) of the cavities 60 with the light absorbing material 56 can be performed in-line or on a continuous basis with the methods for forming the microstructured composite 90. Regardless, and returning to FIG. 2B, the optional third film or layer 54, in some embodiments, is then applied (e.g., laminated) to the embedded microstructured film. Where provided, the third film 54 serves as a protective shield to the microstructured composite 90, and can be adhered thereto using, for example, an optically clear adhesive. In other embodiments, the third film 54 can be provided as part of a screen otherwise initially maintaining the light absorbing material 56 as described in US Publication No. 2005/0127541, and that is brought together with the microstructured composite 90 while simultaneously inserting the light absorbing material 56 into the cavities 60. Alternatively, the third film 54 can be omitted. Regardless, the light control film 22 (with or without the third layer or film 54) results.

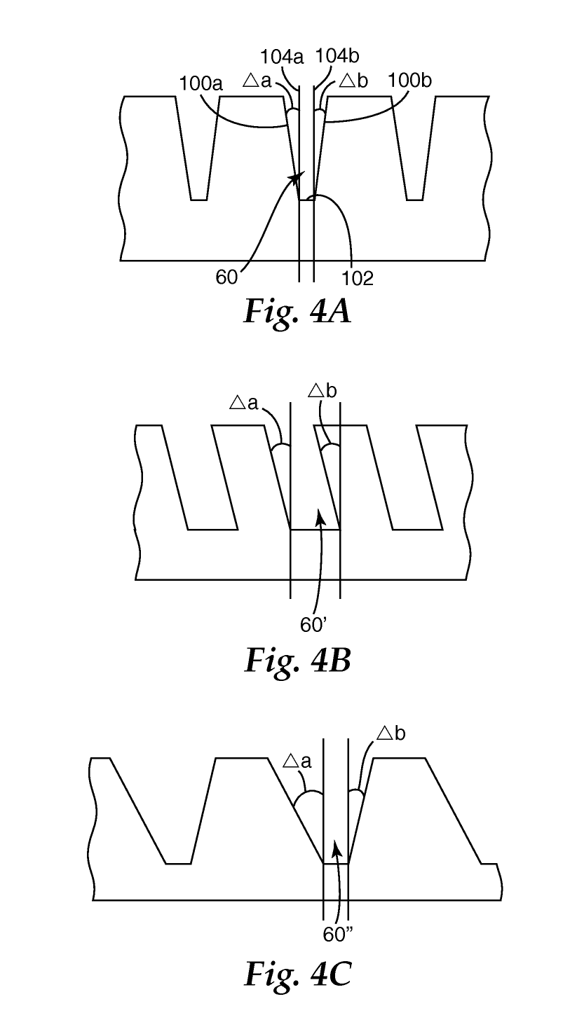

As is clear from the above, the methods associated with manufacturing the light control film 22 for use with the LCD device 20 (FIG. 1) represent a marked departure from conventional approaches normally employed for internal LCD device applications. Namely, skiving is not employed, such that the inherent birefringence-causing stresses associated with skiving are not present. Further, casting and molding methodologies are characterized by a high uniformity in the formed microstructures 58/cavities 60 as compared to skiving techniques. For example, and with reference to FIG. 4A, each of the microcavities 60 is defined (in transverse cross-section) by opposing, first and second walls 100a, 100b that extend from a floor 102. Each wall 100a, 100b defines a wall angle Δa, Δb relative to a reference plane passing through a point of intersection of the wall 100a, 100b with the floor 102 in an orientation perpendicular to a plane of the base layer 50. FIG. 4A illustrates a first reference plane 104a relative to the first wall 100a and a second reference plane 104b relative to the second wall 100b. From these wall angles Δa, Δb, a louver angle for the microcavity 60 in question can be defined as the local average of the two wall angles Δa, Δb, and usually corresponds with the viewing angle at which brightness or transmission is at a maximum. Generally, the highest transmission or brightness will occur at viewing angles parallel to the louver angle. As a point of reference, FIG. 4A illustrates symmetric louvers or cavities 60, where Δa equals the negative of Δb; FIG. 4B illustrates slanted louvers or cavities 60′ that are parallel, with Δa equaling Δb; and FIG. 4C illustrates asymmetric louvers or cavities 60″ (e.g., sawtooth structure), where a magnitude of Δa is greater than a magnitude of Δb.

Given the above, transmission or brightness uniformity is achieved when little variation exists in louver angle across all of the microcavities 60. The above-described molding methodologies used in generating the light control film 22 results in a much smaller variation in louver angle as compared to skiving technologies used in the manufacture of light control film for internal LCD device applications. For example, in some embodiments, a variation of the louver angle not more than ±2 degrees across the light control film 22. In contrast, conventional skiving techniques are characterized by a variation in louver angle on the order of ±8 degrees.

In addition to the manufacturing techniques described above, aspects of the present disclosure include selection of low birefringence material(s) for the first, second, and third layers 50-54. As mentioned above, the second layer 52 is formed of a transparent curable resin (e.g., mixed acrylate blend) that inherently is low birefringence. Further, the first and third films 50, 54 are both formed of a low birefringence polymeric resin material (e.g., a material exhibiting less than 20 nm optical retardence). For example, one or both of the first and third films 50, 54 are formed of a low birefringence polycarbonate material such as a material available from KEIWA Inc., of Osaka, Japan, under the product designation PCLR200. Other low birefringence polymeric films, such as a poly methyl methacrylate (PMMA), cellulose triacetate, and cellulose acetate butyrate, may also be employed. As a point of reference, in the general context of light control privacy film, use of polycarbonate films has previously been considered, but a low birefringence polycarbonate film has not. It is surmised that this failure in the prior art flows from the fact that with typical light control film applications (e.g., privacy film), birefringence is of little or no concern.

The light absorbing material 56 can be comprised of one or more materials exhibiting ambient light absorbing properties. The light absorbing material 56 typically is or incorporates a black pigment or dye. One suitable pigment is carbon black dispersed within a suitable binder. Other acceptable light absorbing materials can include particles or other scattering elements that can function to block light from being transmitted through the cavity 60. The light absorbing material 56 may comprise substantially the same polymerizable resin composition as one or more of the layers 50-54 with the exception of the inclusion of pigment or dye. The amount of colorant (e.g., carbon black) is typically at least 2 wt-% and no greater than about 10 wt-%. One exemplary light absorbing composition is described in Example 3 of U.S. Pat. No. 6,398,370.

The above-described manufacturing methodologies in combination with the selected low birefringence film materials (e.g., low birefringence polycarbonate) result in the light control film (or composite light control film) 22 exhibiting uniform, low birefringence properties in accordance with principles of the present disclosure. These properties of the light control film 22 are characterized by the minimal impact on brightness and/or color uniformity of the LCD device 20 (FIG. 1) upon final assembly. That is to say, a brightness variation and/or color variation of the LCD device 20 is essentially identical with and without the light control film 22, and are represented by Brightness Variation Factors and Color Variation Factors (as defined below). In general terms, the light control film 22 exhibits a Brightness Variation Factor of less than 10%, alternatively less than 6%, alternatively less than 5%, and alternatively less than 4%. In addition or alternatively, the light control film exhibits a color variation factor of less than 10%, alternatively less than 6%, alternatively, less than 5%, and alternatively less than 4%. These represent improvements over conventional light control films, especially those used in LCD device applications.

The low birefringence light control film 22 can be employed in a variety of end use applications. One such application is with display devices, including LCD display assemblies. For example, returning to FIG. 1, following formation of the light control film 22 as described above, the LCD device 20 can be assembled. For example, the LCD assembly 24 and the backlight unit 26 can be assembled within a housing (not shown), with the light control film 22 optically disposed between the light chamber 34 and the rear polarizer 32 of the LCD assembly 24. The housing can assume a variety of shapes and/or sizes, and in some configurations is adapted for mounting within an automotive vehicle's dashboard, with the LCD device 20 further including a controller programmed to (or operating upon software programmed to) perform desired display operations such as displaying maps/driving directions. During use, the light control film 22 serves to control the propagation directions of the light beams delivered from the light chamber 34 to the LCD assembly 24, establishing a specific exiting angle range. In this regard, due to the highly uniform nature of the microstructures 58/cavities 60 (and thus of the light absorbing material 56 disposed within the cavities 60 as shown in FIG. 2B) as described above, the desired exiting angle range of light beams from the LCD assembly 24 is tightly controlled. In addition, the light control film 22 does not impart an overt non-uniformity onto the light beams passed (from the light chamber 34) through to the LCD assembly 24. While the LCD device 20 has been illustrated and described with the light control film 22 oriented such that the microcavities 60 “face” the LCD assembly 24 (i.e., the base or first film 50 is optically adjacent the light chamber 34), an opposite orientation is also acceptable. In other words, the light control film 22 can be oriented 180° from the orientation of FIG. 1 such that the microcavities 60 “face” the light chamber 34.

The minimal, uniform birefringence characteristics of the light control film 22 give rise to further improvements with other LCD device constructions. For example, FIG. 5 schematically illustrates an alternative LCD device 150 in accordance with aspects of the present disclosure. The LCD device 150 is similar in many respects to the LCD device 20 (FIG. 1) previously described, and includes the LCD assembly 24 and the backlight unit 26 having the light chamber 34. In addition, the LCD device 150 includes the light control film 22 as previously described, as well as at least one brightness enhancement film 152. The brightness enhancement film 152 is optically positioned between the light chamber 34 and the LCD assembly 24, and serves to increase an effective brightness of light delivered to, and thus exiting from, the LCD assembly 24.

In some embodiments, the brightness enhancement film 152 is a reflective polarizer configured to manage light in the LCD device 150 by transmitting one polarization state (corresponding with a polarizing optic axis of the rear polarizer 32) from the light chamber 34 to the LCD assembly 24, while reflecting the other polarization state back to the light chamber 34. In this manner, light that would normally be absorbed by the rear polarizer 32 of the LCD assembly 24 is recycled, increasing an overall amount of light exiting the LCD device 150. For example, Vikuiti® brand Dual Brightness Enhancement Films (DBEF), available from 3M Company, can be used as the brightness enhancement film 152. Regardless, where the brightness enhancement film 152 is a reflective polarizer, the LCD device 150 is, in some embodiments, arranged such that the reflective polarizer brightness enhancement film 152 is optically between the light chamber 34 and the light control film 22, whereas the light control film 22 is optically between the reflective polarizer brightness enhancement film 152 and the LCD assembly 24. In other words, the managed, polarized light transmitted from the brightness enhancement film 152 is acted upon by the light control film 22 as described above, and subsequently passed to the LCD assembly 24. With this construction, the uniform, low birefringence properties of the light control film 22 are beneficial. In particular, because the light control film 22 introduces very minimal, if any, non-uniform birefringence into light directed to the LCD assembly 24, overall transmission and brightness of the LCD device 150 is minimally affected by presence of the light control film 22. That is to say, presence of the light control film 22 does not generate significant variations in the display brightness via negatively affecting the alignment desired between the reflective polarizer brightness enhancement film 152 and the rear polarizer 32 of the LCD assembly 24. However, the light control film 22 beneficially controls the propagation directions of light beams delivered to the LCD assembly 24 as described above.

Commensurate with the above explanations, manufacturing of the LCD device 150 further includes, in some embodiments, providing the light control film 22 and the brightness enhancement film 152 (e.g., a reflective polarizer) as a composite structure or film stack, followed by assembly of the film stack within the LCD device 150 (i.e., optically between the light chamber 34 and the LCD assembly 24). For example, the light control film 22 can be formed by any of the methods described above. The so-formed light control film 22 is then affixed to the brightness enhancement film 152 (prior to assembly to the light chamber 34 or other component of the LCD device 150). For example, an optically clear adhesive can be employed to bond or laminate the light control film 22 to the brightness enhancement film 152. Other assembly techniques are also envisioned. Regardless, in some embodiments the film stack exhibits a Brightness Variation Factor of less than 10%, alternatively less than 5%. In addition or alternatively, the film stack exhibits a Color Variation Factor of less than 10%, alternatively less than 5%.

One or more other types of brightness enhancement film(s) 152 can be employed, in addition, or as an alternative, to the reflective polarizer construction described above. For example, in other embodiments, the LCD device 150 includes a prismatic film that redirects light exiting the light chamber 34 at particular angles relative to the prismatic film. The light redirected by the prismatic film can also be recycled, eventually being transmitted to the LCD assembly 24 at an angle that will pass through the prismatic film. For example, Vikuiti® brand Brightness Enhancement Film (BEF), available from 3M Company, can be used as the prismatic film. Alternatively, the prismatic film may comprise Vikuiti® brand Transmissive Right Angle Film (TRAF), also available from 3M Company. The TRAF redirects light coming in at high angles to exit at different angles. Regardless, the prismatic film can serve as the brightness enhancement film 152, or can be provided in addition to another brightness enhancement film otherwise provided in a different form (e.g., the LCD device 150 can includes a prismatic film and a reflective polarizer film as two brightness enhancement films 152).

Even further, the LCD device 150 can include other enhancement films, such as a Vikuiti® brand Enhanced Specular Reflector (ESR) films to further increase the efficiency of the LCD device 150. Other optional components include a diffuser film. In general terms, the diffuser film diffuses incoming light so that the intensity of the light is more spatially uniform. Light coming from one or more point sources may be much more intense at particular locations on an incident face of the diffuser film. Light that exits the diffuser film, however, will be more uniform in intensity across the exit surface of the diffuser film. Once again, the diffuser film can be used as the brightness enhancement film 152, or in addition to the brightness enhancement film 152 otherwise provided in a different form.

Regardless of an exact construction of the LCD device 20 (FIG. 1), 150 (FIG. 5), the light control film 22 in conjunction with the materials and methods of manufacture described above, provides a marked improvement over previous LCD device constructions in ways not previously considered. The light control film 22 provides desired control over the transmission angle of light exiting the LCD device 20, 150. Further, the uniform, low birefringent properties of the light control film 22 has minimal or no effect on light beam polarization, and thus has little or no negative impact upon overall brightness or color uniformity of the LCD device 20, 150, including LCD devices with a reflective polarizer brightness enhancement film.

Brightness Variation Factor

The Brightness Variation Factor represents the affect a light control film has on brightness uniformity associated with an LCD device. Optimally, an LCD device has 100% uniformity in brightness across an entirety of the corresponding viewing face. However, even in the absence of an internal light control film, variations in brightness will be present. The Brightness Variation Factor is a measure of the increase or change in the inherent brightness variation of the LCD device when the light control film is added.

The Brightness Variation Factor of a light control film is determined by comparing luminance uniformity of an LCD-type device with and without the light control film present. In particular, luminance values are measured at multiple locations along the viewing face of the LCD-type device, and the maximum and minimum luminance values noted. This process is performed without the light control film and with the light control film added (i.e., optically between the light source and the viewing face). Luminance Uniformity is calculated as:

$$Luminance Uniformity = 100 \% \times ( \frac{L min }{L max} ) , \qquad Equation ( 1 )$$

where

Lmin=minimum luminance; and

Lmax=maximum luminance.

The Luminance Uniformity Values are then compared to determine the Brightness Variation Factor as:

$$Brightness Variation Factor = \vert \frac{LU with - LUwithout}{LUwithout} \vert \times 100 , \qquad Equation ( 2 )$$

where:

LUwith=determined Luminance Uniformity with the light control film; and

LUwithout=determined Luminance Uniformity without the light control film.

As a point of reference, a higher Luminance Uniformity is indicative of a more constant uniformity over the viewing area. Further, a lower Brightness Variation Factor is indicative of the light control film having lesser effect on brightness uniformity.

The locations along the viewing face at which the luminance measurements are taken can vary, so long as for any one particular light control film test, luminance measurements are taken at the same number and at approximately the same points without and with the light control film being present. In one embodiment, the Brightness Variation Factor is determined by designating a 6 inch×6 inch area on the viewing face, and measuring axial brightness at thirteen spaced locations, as graphically represented in FIG. 6.

Color Variation Factor

The Color Variation Factor represents the affect a light control film has on a color uniformity associated with an LCD device. Optimally, an LCD device has 100% uniformity in expected color across an entirety of the corresponding viewing face. However, even in the absence of an internal light control film, variations in expected color will be present. The Color Variation Factor is a measure of the increase or change in how well the color remains constant when the light control film is added.

The Color Variation Factor of a light control film is determined by comparing color uniformity of an LCD-type device with and without the light control film present. In particular, chromaticity data (e.g., CIE31) are taken at multiple locations along the viewing face of the LCD-type device, and the maximum and minimum chromacity coordinate values (e.g., x, y chromacity coordinates) noted. This process is performed without the light control film and with the light control film added (i.e., optically between the light source and the viewing face). The x, y chromacity coordinates data are converted to (u′, v′) coordinates as follows:

$${u}^{′} = \frac{4 x}{3 + 12 y - 2 x} , {v}^{′} = \frac{9 y}{3 + 12 y - 2 x} . \qquad Equation ( 3 )$$

The maximum and minimum u′, v′ values are used to determine a maximum color nonuniformity (Δu′, v′) as follows:

Δu′v′=\sqrt{(u₁′−u₂′)²+(v₁′−v₂′)²}, Equation (4)

where (u₁′, v₁′) and (u₂′, v₂′) are any two colors.

The maximum color nonuniformity values are then compared to determine the Color Variation Factor as:

$$Color Variation Factor = \vert \frac{CUwith - CUwithout}{CUwthout} \vert \times 100 , \qquad ( Equation 5 )$$

where:
CUwith=maximum color nonuniformity value with the light control film; and
CUwithout=maximum color nonuniformity value with the light control film.

As a point of reference, according to Video Electronics Standards Association Display Metrology Committee Flat Panel Display Measurement Standard, Version 2.0, Section 306, two adjacent color patches can usually be distinguished with a Δu′v′≧0.004. For separated colors, a shift of Δu′v′≧0.04 may be required to distinguish a change.

The locations along the viewing face at which the color nonuniformity measurements are taken can vary, so long as for any one particular light control film test, color nonuniformity measurements are taken at the same number and at approximately the same points without and with the light control film being added. In one embodiment, the Color Variation Factor is determined by designating a 6 inch×6 inch (15 cm×15 cm) area on the viewing face, and measuring axial color at thirteen spaced locations, as graphically represented in FIG. 6.

### EXAMPLE AND COMPARATIVE EXAMPLES

For each of the following example and comparative examples, a light control film was provided as listed and then subjected to testing to determine corresponding Brightness Variation Factor and Color Variation Factor values. In particular, the testing consisted of preparing an apparatus akin to an LCD device benefiting from polarization preservation, including two absorbing polarizer sheets laminated to glass using an optically clear transfer adhesive. The first absorbing polarizer sheet was positioned on top of a light box, with the glass between the light box and the polarizer sheet. The second absorbing polarizer sheet was positioned above the first polarizer sheet such that the second absorbing polarizer faced the first absorbing polarizer and the respective pass axes were aligned with each other. The light box and polarizer sheets were mounted on a test bed. Luminance measurements were made using a PR-705 Spot Spectroradiometer (available from Photo Research). The radiometer was positioned approximately 1 meter from the test bed. The radiometer was mounted in a manner that allowed for precise translation in two directions. The axial brightness was measured at 13 different locations across a 6 inch×6 inch (15 cm×15 cm) area of the display in accordance with the grid shown in FIG. 6.

Measurements were made at the following conditions: (1) no absorbing polarizer film sheets (light box only), (2) absorbing polarizer film sheets only, and (3) light control film samples positioned between the absorbing polarizer films such that both the louvers and the first and third layer films optical axes were at an approximate 45 deg bias angle with respect to the optical axes of the absorbing polarizer film sheets.

### Example #1

A low birefringence polycarbonate film (less than 20 nm optical retardance) supplied by KEIWA Inc., was used to make a light control film in accordance with the arrangement of FIG. 2B via a casting methodology. In particular, the low birefringence polycarbonate film was used as the first and third layers 50, 54, whereas an acrylate material was used as the microreplicated, second layer 52. The light absorbing material 56 was similar to that described in Example 3 of U.S. Pat. No. 6,398,370.

### Comparative Example #1

A commercially available privacy filter sold by 3M (Notebook Privacy Filter PF14.1) made using microreplication technology.

### Comparative Example #2

A commercially available privacy filter distributed by Elecom Co., Ltd., of Osaka, Japan (Elecom Notebook Privacy Filter) and made using microreplication technology.

### Comparative Example #3

A commercially available privacy filter distributed by Shehwa P&C of Korea (Magic Screen Notebook and LCD Privacy Protection Filter) and made using a non-microreplication technology process. It is believed to be made using skiving technology.

Results

Axial luminance and CIE31 chromaticity coordinates for the light box alone are set forth in Table I below. Measured values for the light box in combination with the light absorbing polarizers are set forth in Table II. Finally, the measure values for each of the Example and Comparative Examples are provided in Tables III-VI.

TABLE I
(Light Box Only)

| Grid Location | Luminance | CIE31x | CIE31y |
|---|---|---|---|
| 10/90 | 6310 | 0.3952 | 0.4015 |
| 50/90 | 6659 | 0.3951 | 0.4013 |
| 90/90 | 6338 | 0.3951 | 0.4012 |
| 10/50 | 6356 | 0.3942 | 0.4005 |
| 50/50 | 6665 | 0.3939 | 0.4000 |
| 90/50 | 6372 | 0.3941 | 0.4002 |
| 10/10 | 6336 | 0.3936 | 0.4001 |
| 50/10 | 6604 | 0.3934 | 0.3997 |
| 90/10 | 6416 | 0.3934 | 0.3995 |
| 30/70 | 6357 | 0.3926 | 0.4003 |
| 70/70 | 6328 | 0.3927 | 0.4004 |
| 30/30 | 6663 | 0.3948 | 0.4002 |
| 70/30 | 6707 | 0.3945 | 0.4001 |

TABLE II
(Plates and Light Box)

| Grid Location | Luminance | CIE31x | CIE31y |
|---|---|---|---|
| 10/90 | 2368 | 0.4086 | 0.4159 |
| 50/90 | 2436 | 0.4087 | 0.4161 |
| 90/90 | 2346 | 0.4086 | 0.4164 |
| 10/50 | 2448 | 0.4071 | 0.4149 |
| 50/50 | 2533 | 0.4072 | 0.4150 |
| 90/50 | 2441 | 0.4073 | 0.4152 |
| 10/10 | 2550 | 0.4059 | 0.4139 |
| 50/10 | 2647 | 0.4062 | 0.4142 |
| 90/10 | 2540 | 0.4064 | 0.4144 |
| 30/70 | 2390 | 0.4057 | 0.4150 |
| 70/70 | 2395 | 0.4057 | 0.4150 |
| 30/30 | 2632 | 0.4077 | 0.4148 |
| 70/30 | 2623 | 0.4080 | 0.4154 |

TABLE III
(Example #1)

| Grid Location | Luminance | CIE31x | CIE31y |
|---|---|---|---|
| 10/90 | 1280.00 | 0.4126 | 0.4195 |
| 50/90 | 1337.00 | 0.4129 | 0.4195 |
| 90/90 | 1273.00 | 0.4134 | 0.4202 |
| 10/50 | 1323.00 | 0.4115 | 0.4185 |
| 50/50 | 1384.00 | 0.4116 | 0.4184 |
| 90/50 | 1318.00 | 0.4120 | 0.4192 |
| 10/10 | 1368.00 | 0.4112 | 0.4184 |
| 50/10 | 1430.00 | 0.4108 | 0.4181 |
| 90/10 | 1372.00 | 0.4103 | 0.4176 |
| 30/70 | 1313.00 | 0.4101 | 0.4182 |
| 70/70 | 1299.00 | 0.4104 | 0.4187 |
| 30/30 | 1424.00 | 0.4120 | 0.4185 |
| 70/30 | 1424.00 | 0.4121 | 0.4187 |

TABLE IV
(Comparative Example #1)

| Grid Location | Luminance | CIE31x | CIE31y |
|---|---|---|---|
| 10/90 | 302.6 | 0.2501 | 0.2975 |
| 50/90 | 759.8 | 0.3157 | 0.3830 |
| 90/90 | 584.4 | 0.2950 | 0.3591 |
| 10/50 | 1294 | 0.4040 | 0.4647 |
| 50/50 | 533.7 | 0.2822 | 0.3426 |
| 90/50 | 716.7 | 0.3129 | 0.3791 |
| 10/10 | 1377 | 0.4616 | 0.4887 |
| 50/10 | 966.5 | 0.3424 | 0.4111 |
| 90/10 | 699.6 | 0.3066 | 0.3715 |
| 30/70 | 315.4 | 0.2477 | 0.2954 |
| 70/70 | 808.2 | 0.3258 | 0.3947 |
| 30/30 | 1203 | 0.3765 | 0.4434 |
| 70/30 | 662.2 | 0.2999 | 0.3644 |

TABLE V
(Comparative Example #2)

| Grid Location | Luminance | CIE31x | CIE31y |
|---|---|---|---|
| 10/90 | 469.3 | 0.4493 | 0.3729 |
| 50/90 | 522.1 | 0.4282 | 0.3813 |
| 90/90 | 487.3 | 0.4401 | 0.375 |
| 10/50 | 525.2 | 0.4519 | 0.3854 |
| 50/50 | 557.4 | 0.446 | 0.3877 |
| 90/50 | 529.2 | 0.4275 | 0.3901 |
| 10/10 | 675.3 | 0.4261 | 0.3987 |
| 50/10 | 593.2 | 0.4336 | 0.3915 |
| 90/10 | 541.1 | 0.4468 | 0.3851 |
| 40/70 | 504.8 | 0.4485 | 0.3809 |
| 70/70 | 532.6 | 0.4205 | 0.3925 |
| 30/30 | 588.3 | 0.4405 | 0.3904 |
| 70/30 | 574 | 0.444 | 0.3883 |

TABLE VI
(Comparative Example #3)

| Grid Location | Luminance | CIE31x | CIE31y |
|---|---|---|---|
| 10/90 | 1037 | 0.4234 | 0.4215 |
| 50/90 | 796.2 | 0.4293 | 0.3736 |
| 90/90 | 1149 | 0.4048 | 0.4484 |
| 10/50 | 1023 | 0.3782 | 0.4399 |
| 50/50 | 982 | 0.3701 | 0.4373 |
| 90/50 | 859.8 | 0.3694 | 0.4240 |
| 10/10 | 1065 | 0.3880 | 0.4418 |
| 50/10 | 1166 | 0.4132 | 0.4473 |
| 90/10 | 1039 | 0.3818 | 0.4368 |
| 30/70 | 1049 | 0.4235 | 0.4330 |
| 70/70 | 971.7 | 0.4486 | 0.4125 |
| 30/30 | 685 | 0.4015 | 0.4014 |
| 70/30 | 779.2 | 0.4329 | 0.3848 |

The Luminance Uniformity for each light control film is tabulated at Table_VII. The uniformity was calculated using Equation (1) and the data shown in Tables I-VI.

TABLE VII

| | Sample ID | | | | | |
|---|---|---|---|---|---|---|
| | | | | | Polarizers | Light |
| | Exam- | Comp | Comp | Comp | w/ | box |
| | ple 1 | Ex 1 | Ex 2 | Ex 3 | light box | only |
| Luminance | 89.0% | 22.0% | 69.5% | 58.7% | 88.6% | 94.1% |
| Uniformity | | | | | | |

A luminance uniformity of 100% would represent no change in luminance across the surface of the display. The Example 1 light control film yielded a significantly higher luminance uniformity than all of the Comparative Example films, which should translate into a more uniformly bright display. This unexpected improvement is further exemplified by the Brightness Variation Factor (BVF) determined for each of the tested light control films, as set forth in Table VIII below:

TABLE VIII

| Sample ID | Example 1 | Comp Ex 1 | Comp Ex 2 | Comp Ex 3 |
|---|---|---|---|---|
| BVF (%) | 0.45 | 75.2 | 21.6 | 33.7 |

The chromaticity coordinate data in Table III-VI were converted to (u′, v′) coordinates using Equation (3). The maximum and minimum values were substituted into Equation (4) to determine the maximum color nonuniformity seen for each sample type. The resulting color uniformity for each example is given in Table IX.

TABLE IX

| | Sample ID | | | | | |
|---|---|---|---|---|---|---|
| | | | | | Polarizers | Light |
| | Exam- | Comp | Comp | Comp | w/ | box |
| | ple 1 | Ex 1 | Ex 2 | Ex 3 | light box | only |
| Color | 0.0042 | 0.2883 | 0.0406 | 0.1089 | 0.0039 | 0.0033 |
| Uniformity | | | | | | |

According to the Video Electronics Standards Association Display Metrology Committee's recommendations, one can readily expect to notice differences in color for both Comparative Examples 1 and 3. Example 1 is not expected to introduce noticeable changes in color. Comparative Example 2 yielded a color uniformity that is one order of magnitude greater than Example 1. A noticeable change in color can thus be expected if the light control film of Comparative Example 2 were used. This difference is further exemplified by the Color Variation Factor (CVF) determined for each of the test light control films as set forth in Table X below:

TABLE X

| Sample ID | Example 1 | Comp Ex 1 | Comp Ex 2 | Comp Ex 3 |
|---|---|---|---|---|
| CVF (%) | 7.7 | 7,292 | 941 | 2,692 |

The LCD device of the present disclosure is highly useful in many applications. One particular application is as an on-board vehicle display, such as the display of a vehicle navigation system. With these and other similar end use applications, available space constraints dictate that light beam propagation control be provided (via a light control film) and that the LCD device must be of a fairly limited size. This, in turn, necessitates that the internal lighting system employed with the LCD device is relatively small. As such, the need to employ a brightness enhancement film is of importance. Where the selected brightness enhancement film(s) includes a reflective polarizer, the selected light control film optimally does not introduce any deleterious birefringence into the system. The light control film 22 of the present disclosure provides this desired attribute, and can be generated on a mass production basis with minimal waste due to birefringence properties outside of an accepted range. For example, it has surprisingly been found that the light control film 22 described above can be mass produced to exhibit uniform birefringence with a very low rejection rate. In contrast, skiving-produced light control film for LCD device applications, when mass produced, have rejection rates on the order of 30 percent or more due to unacceptably high, non-uniform birefringence properties.

Although the present disclosure has been described with reference to preferred embodiments, workers skilled in the art will recognize that changes can be made in form and detail without departing from the spirit and scope of the present disclosure. For example, while particular shapes for light diffusive and light absorbing structures are illustrated, it is contemplated that the structures can be formed in different shapes, incorporating additional or different planes or angles, additional edges, and curved surfaces, etc. While the low birefringence light control film has been described as being used as an internal component of an LCD device, a variety of other end use applications, including display and non-display products, are envisioned.

What is claimed is:

1. A method of manufacturing a composite light control film, the method comprising:
providing a first layer as a film;
providing a second layer in a formable state;
patterning the formable second layer to form a plurality of microstructures, the plurality of microstructures defining a plurality of cavities therebetween;
solidifying the patterned second layer on the first layer;
filling the cavities with a light absorbing material; and
forming a composite light control film including the cavities filled with the light absorbing material;
wherein the composite light control film exhibits a Brightness Variation Factor of less than 10%.

2. The method of claim 1, wherein the composite light control film exhibits a Brightness Variation Factor of less than 5%.

3. The method of claim 1, wherein the composite light control film exhibits a Color Variation Factor of less than 10%.

4. The method of claim 1, further comprising:
attaching a third layer as a film to the second layer opposite the first layer after filing the cavities with a light absorbing material.

5. The method of claim 4, wherein the composite light control film exhibits a Brightness Variation Factor of less than 5%.

6. The method of claim 4, wherein the composite light control film exhibits a Color Variation Factor of less than 10%.

7. The method of claim 1, wherein the first layer has a birefringence of less than 20 nm optical retardance.

8. The method of claim 7, wherein the first layer is polycarbonate.

9. The method of claim 8, wherein a material of the second layer is a (meth)acrylate-containing polymer.

10. The method of claim 1, wherein the plurality of cavities each define louver angle, and further wherein the composite light control film is characterized by a variation in the louver angle of each of the cavities relative to remaining ones of the cavities of less than 2 degrees.

11. The method of claim 1, further comprising coating the second layer on the first layer prior to the step of patterning the second layer.

12. The method of claim 1, further comprising:
securing a reflective polarizer film to the composite light control film.

13. A method of manufacturing an LCD device, the method comprising:
forming a composite light control film with the method of claim 1; and
disposing the composite light control film between a liquid crystal display assembly and a light chamber of a backlight unit.

14. The method of claim 13, wherein the liquid crystal display assembly includes a liquid crystal display panel positioned between a front polarizer and a rear polarizer and further wherein disposing the composite light control film includes positioning the composite light control film optically between the rear polarizer and the light chamber.

15. The method of claim 13, wherein disposing the composite light control film between a light chamber and a liquid crystal display assembly includes:
optically positioning the composite light control film between a brightness enhancement film and the liquid crystal display assembly.

16. The method of claim 15, wherein the brightness enhancement film is a reflective polarizer film.

17. The method of claim 16, further comprising:
securing the composite light control film to the reflective polarizer film.

18. The method of claim 17, wherein securing the composite light control film to the reflective polarizer film includes laminating the composite light control film and the reflective polarizer film to one another.

19. An LCD device comprising:
a liquid crystal display assembly including:
a liquid crystal display panel defining a front side and a back side,
a front polarizer optically adjacent the front side of the liquid crystal display panel,
a rear polarizer optically adjacent the back side of the liquid crystal display panel;
a backlight unit including a light chamber; and
a composite light control film optically between the liquid crystal display assembly and the light chamber, the light control film including:
a low birefringence base film,
an intermediate layer formed on the base film to define a first major face opposite the base film, the intermediate layer forming a plurality of microstructures defining a plurality of cavities therebetween, the cavities being open relative to a first major face of the intermediate layer,
a light absorbing material disposed within the cavities,
wherein the composite light control film exhibits a Brightness Variation Factor of less than 10%.

20. The LCD device of claim 19, wherein the base film is formed of a polycarbonate material.

21. The LCD device of claim 19, wherein the composite light control film further includes a low birefringence top film adhered to the first major face of the intermediate layer.

22. The LCD device of claim 19, further comprising a reflective polarizer film is secured to the composite light control film.

23. The LCD device of claim 19, wherein the LCD device is configured for assembly within a dashboard of an automobile.

24. A composite light control film for use in an LCD device including a liquid crystal display assembly and a backlight unit, the composite light control film comprising:
a first low birefringence film;
an intermediate layer defining opposing, first and second major faces and a plurality of microstructures defining a plurality of cavities therebetween, wherein the cavities are open relative to the first major face and the second major face contacts the first film; and
a light absorbing material disposed within each of the cavities;
wherein the composite film exhibits a Brightness Variation Factor of less than 10%.
